(19) United States
(12) Patent Application Publication
(10) Pub. No.: US 2026/0112972 A1
(43) Pub. Date: Apr. 23, 2026

(54) POWER CONVERTER HAVING VOLTAGE MODULATED BASED ON LOW-SIDE SENSED DATA

(71) Applicant: ANPEC ELECTRONICS CORPORATION, HSINCHU (TW)

(72) Inventor: CHIH-NING CHEN, TAIPEI CITY (TW)

(21) Appl. No.: 19/013,841

(22) Filed: Jan. 8, 2025

(30) Foreign Application Priority Data
Oct. 17, 2024 (TW) 113139454

(51) Int. Cl. H02M 3/158; H02M 1/00; H02M 1/08

(52) U.S. Cl. CPC H02M 3/158; H02M 1/0009; H02M 1/08

(57) ABSTRACT

A power converter having a voltage modulated based on low-side sensed data is provided. The power converter includes a high-side switch, a low-side switch, a feedback circuit, a current sensing modulation circuit, a comparison circuit, a control circuit and a driver circuit. The feedback circuit outputs a feedback signal according to a voltage of an inductor. The current sensing modulation circuit senses a current that flows from an output terminal of the power converter through the inductor and the low-side switch, and modulates the feedback signal or a ramp voltage (or a duty cycle) according to the current. The comparison circuit compares a voltage of the feedback signal with the ramp voltage to output a first comparing signal. The control circuit outputs a control signal according to the first comparing signal. The driver circuit drives the high-side and the low-side switch according to the control signal.

### CROSS-REFERENCE TO RELATED PATENT APPLICATION

This application claims the benefit of priority to Taiwan Patent Application No. 113139454, filed on Oct. 17, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a power converter, and more particularly to a power converter having a voltage modulated based on low-side sensed data.

### BACKGROUND OF THE DISCLOSURE

Power converters are indispensable for electronic devices. The power converters are used to adjust power and supply the adjusted power to the electronic devices. Switch components of the power converter must be switched according to data such as voltages or currents of circuit components of the power converter, such that the power converter can supply sufficient power to a load.

However, when conventional power convertors switch from a pulse-frequency modulation (PFM) mode to a frequency pulse width modulation (FPWM) mode, an on-time of a high-side switch of each of the conventional power convertors cannot be effectively controlled. In the conventional power convertor, the high-side switch is often turned on for a long period of time, such that a low-side switch is damaged by an excessive current that flows from an inductor to the low-side switch. When a load connected to the conventional power convertor transits from a (super) light load to a medium load or a heavy load, power required for the load is increased. At this time, the low-side switch of the conventional power convertor is not instantly turned off and the high-side switch is not instantly turned on. As a result, the conventional power convertor supplies insufficient power to the load for operation.

### SUMMARY OF THE DISCLOSURE

In response to the above-referenced technical inadequacies, the present disclosure provides a power converter having a voltage modulated based on low-side sensed data. The power converter includes a high-side switch, a low-side switch, a feedback circuit, a current sensing modulation circuit, a comparison circuit, a control circuit and a driver circuit. A first terminal of the high-side switch is coupled to an input voltage. A first terminal of the low-side switch is connected to a second terminal of the high-side switch. A second terminal of the low-side switch is grounded. A node between the first terminal of the low-side switch and the second terminal of the high-side switch is connected to a first terminal of an inductor. A second terminal of the inductor is used as an output terminal of the power converter. The feedback circuit is connected to the second terminal of the inductor. The feedback circuit is configured to output a feedback signal according to an output voltage of the second terminal of the inductor. The current sensing modulation circuit is connected to the feedback circuit. The current sensing modulation circuit is configured to sense a current that flows from the output terminal of the power converter sequentially through the inductor and the low-side switch. The current sensing modulation circuit is configured to modulate the feedback signal or a ramp voltage according to the current being sensed. The comparison circuit is connected to the feedback circuit. The comparison circuit is configured to compare a voltage of the feedback signal with the ramp voltage to output a first comparing signal. The control circuit is connected to the comparison circuit. The control circuit is configured to output a control signal according to the first comparing signal. The driver circuit is connected to the control circuit, a control terminal of the high-side switch and a control terminal of the low-side switch. The driver circuit is configured to drive the high-side switch and the low-side switch according to the control signal.

As described above, the present disclosure provides the power converter having the voltage modulated based on the low-side sensed data. In the power converter of the present disclosure, the current sensing modulation circuit (including a current sensing amplifier) senses the current that flows from the inductor to the low-side switch. The current sensing modulation circuit, according to the sensed current, modulates the feedback signal that is outputted to the comparison circuit based on the output voltage of the power converter, or modulates the ramp voltage that is compared with the feedback signal. As a result, in the power converter of the present disclosure, the control circuit more quickly switches the high-side switch and the low-side switch according to the first comparing signal from the comparison circuit. Therefore, the power converter of the present disclosure is capable of more quickly supplying sufficient power to a load connected thereto.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a circuit diagram of a power converter having a voltage modulated based on low-side sensed data according a first embodiment of the present disclosure;

FIG. 2 is a waveform diagram of signals of the power converter having the voltage modulated based on the low-side sensed data according the first embodiment and a second embodiment of the present disclosure;

FIG. 3 is a circuit diagram of the power converter having the voltage modulated based on low-side sensed data according the second embodiment of the present disclosure;

FIG. 4 is a waveform diagram of signals of the power converter having the voltage modulated based on the low-side sensed data according the first and second embodiments of the present disclosure;

FIG. 5 is a waveform diagram of signals of the power converter having the voltage modulated based on the low-side sensed data according the first and second embodiments of the present disclosure;

FIG. 6 is a waveform diagram of signals of the power converter having the voltage modulated based on the low-side sensed data according the first and second embodiments of the present disclosure;

FIG. 7 is a waveform diagram of signals of the power converter having the voltage modulated based on the low-side sensed data according the first and second embodiments of the present disclosure;

FIG. 8 is a circuit diagram of a power converter having a voltage modulated based on low-side sensed data according a third embodiment of the present disclosure;

FIG. 9 is a waveform diagram of signals of the power converter having the voltage modulated based on the low-side sensed data according the third embodiment and a fourth embodiment of the present disclosure;

FIG. 10 is a circuit diagram of the power converter having the voltage modulated based on low-side sensed data according the fourth embodiment of the present disclosure;

FIG. 11 is a waveform diagram of signals of the power converter having the voltage modulated based on the low-side sensed data according the third and fourth embodiments of the present disclosure;

FIG. 12 is a waveform diagram of signals of the power converter having the voltage modulated based on the low-side sensed data according the third and fourth embodiments of the present disclosure;

FIG. 13 is a waveform diagram of signals of the power converter having the voltage modulated based on the low-side sensed data according the third and fourth embodiments of the present disclosure; and

FIG. 14 is a waveform diagram of signals of the power converter having the voltage modulated based on the low-side sensed data according the third and fourth embodiments of the present disclosure and a conventional power converter.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

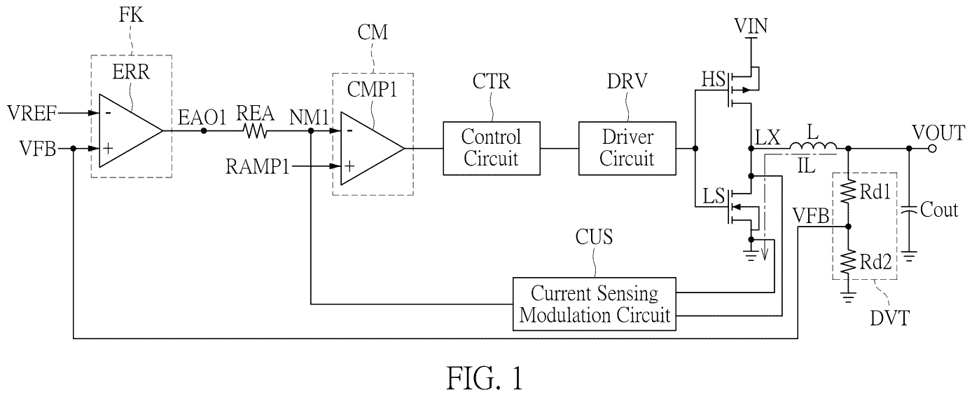

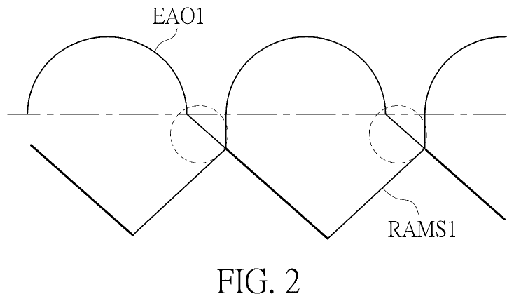

Reference is made to FIG. 1 and FIG. 2, in which FIG. 1 is a circuit diagram of a power converter having a voltage modulated based on low-side sensed data according a first embodiment of the present disclosure, and FIG. 2 is a waveform diagram of signals of the power converter having the voltage modulated based on the low-side sensed data according the first and second embodiments of the present disclosure.

As shown in FIG. 1, the power converter of the first embodiment of the present disclosure includes a high-side switch HS, a low-side switch LS, a feedback circuit FK, a current sensing modulation circuit CUS, a comparison circuit CM, a control circuit CTR and a driver circuit DRV.

A first terminal of the high-side switch HS is coupled to an input voltage VIN. A first terminal of the low-side switch LS is connected to a second terminal of the high-side switch HS. A second terminal of the low-side switch LS is grounded. A node LX between the first terminal of the low-side switch LS and the second terminal of the high-side switch HS is connected to a first terminal of an inductor L. A second terminal of the inductor L may be connected to a first terminal of an output capacitor Cout. A second terminal of the output capacitor Cout is grounded. The second terminal of the inductor L or the first terminal of the output capacitor Cout is used as an output terminal of the power converter of the present disclosure, and is configured to supply an output voltage VOUT. The output terminal of the power converter of the present disclosure may be connected to a load.

If necessary, the power converter of the present disclosure may further include a voltage divider circuit DVT shown in FIG. 1. The voltage divider circuit DVT divides the output voltage VOUT from the second terminal of the inductor L or the first terminal of the output capacitor Cout to output a divided voltage.

The feedback circuit FK may be connected to an input terminal of the voltage divider circuit DVT as shown in FIG. 1. The feedback circuit FK may be connected to an output terminal of the voltage divider circuit DVT as shown in FIG. 1, or may be directly connected to the second terminal of the inductor L or the first terminal of the output capacitor Cout in practice.

For example, the voltage divider circuit DVT may include a first voltage dividing resistor Rd1 and a second voltage dividing resistor Rd2. A first terminal of the first voltage dividing resistor Rd1 is connected to the second terminal of the inductor L or the first terminal of the output capacitor Cout. A second terminal of the first voltage dividing resistor Rd1 is connected to a first terminal of the second voltage dividing resistor Rd2. A second terminal of the second voltage dividing resistor Rd2 is grounded.

An input terminal of the comparison circuit CM is connected to an output terminal of the feedback circuit FK. The current sensing modulation circuit CUS is connected to a modulation node NM1 between the input terminal of the comparison circuit CM and the output terminal of the feedback circuit FK.

An input terminal of the control circuit CTR is connected to an output terminal of the comparison circuit CM. An output terminal of the control circuit CTR is connected to an input terminal of the driver circuit DRV. An output terminal of the driver circuit DRV is connected to a control terminal of the high-side switch HS and a control terminal of the low-side switch LS.

As shown in FIG. 1, the feedback circuit FK receives the divided voltage of the output voltage VOUT from the voltage divider circuit DVT, and outputs a feedback signal EAO1 according to the divided voltage of the output voltage VOUT. In practice, the feedback circuit FK may output the feedback signal EAO1 directly according to the output voltage VOUT from the second terminal of the inductor L or the first terminal of the output capacitor Cout.

For example, as shown in FIG. 1, the feedback circuit FK includes an error amplifier ERR. A first input terminal such as an inverting input terminal of the error amplifier ERR is coupled to a first reference voltage VREF. A second input terminal such as a non-inverting input terminal of the error amplifier ERR is connected to the output terminal of the voltage divider circuit DVT as shown in FIG. 1, or may be directly connected to the second terminal of the inductor L or the first terminal of the output capacitor Cout in practice. The output terminal of the voltage divider circuit DVT may be a node between the second terminal of the first voltage dividing resistor Rd1 and the first terminal of the second voltage dividing resistor Rd2. An output terminal of the error amplifier ERR is connected to the input terminal of the comparison circuit CM.

The divided voltage from the output terminal of the voltage divider circuit DVT (that is, from the node between the second terminal of the first voltage dividing resistor Rd1 and the first terminal of the second voltage dividing resistor Rd2) is used as a feedback voltage VFB and is inputted to the second input terminal such as the non-inverting input terminal of the error amplifier ERR. In practice, the output voltage VOUT of the second terminal of the inductor L or the first terminal of the output capacitor Cout may be directly inputted to the second input terminal of the error amplifier ERR.

The error amplifier ERR multiples a difference between the feedback voltage VFB and the first reference voltage VREF by a gain to output an error amplified signal as the feedback signal EAO1.

If necessary, the power converter of the present disclosure may further include a power receiving component REA shown in FIG. 1. A first terminal of the power receiving component REA is connected to the output terminal of the error amplifier ERR. As shown in FIG. 1, the power receiving component REA is a resistor, but the present disclosure is not limited thereto. In practice, the power receiving component REA shown in FIG. 1 may be replaced with other electronic components each having a voltage that is changed with a change in the feedback signal EAO1 outputted by the feedback circuit FK.

The comparison circuit CM may include a first comparator CMP1. A first input terminal such as an inverting input terminal of the first comparator CMP1 is connected to a second terminal of the power receiving component REA. A second input terminal such as a non-inverting input terminal of the first comparator CMP1 is coupled to a ramp voltage RAMP1 as shown in FIG. 1, or is configured to receive a ramp signal having the ramp voltage RAMP1 from the ramp signal generator in practice. An output terminal of the first comparator CMP1 is connected to the input terminal of the control circuit CTR.

The first comparator CMP1 compares a voltage of the first input terminal of the first comparator CMP1 with the ramp voltage RAMP1 of the second input terminal of the first comparator CMP1 to output a first comparing signal.

An input terminal of the current sensing modulation circuit CUS is connected to or in contact with the first terminal and/or the second terminal of the low-side switch LS. An output terminal of the current sensing modulation circuit CUS is connected to the modulation node NM1 between the second terminal of the power receiving component REA and the first input terminal of the first comparator CMP1.

It should be understood that, the output voltage VOUT of the output terminal of the power converter of the present disclosure (that is the second terminal of the inductor L or the first terminal of the output capacitor Cout) is increased with an increase in a current that flows through the high-side switch HS from the input voltage VIN. The current that flows through the high-side switch HS from the input voltage VIN is a positive current. The output voltage VOUT of the output terminal of the power converter of the present disclosure is decreased with an increase in a current IL that flows from the inductor L to the low-side switch LS. The current IL is a negative current. When the low-side switch LS is turned on, the current IL flows from the inductor L to the low-side switch LS. A flow direction of the current IL is opposite to a flow direction of the positive current that flows from the input voltage VIN through the high-side switch HS to the inductor L.

It is worth noting that, in the first embodiment, when the control circuit CTR controls the driver circuit DRV to turn on the low-side switch LS, the current sensing modulation circuit CUS senses the current IL that flows from the inductor L to the low-side switch LS. Then, the current sensing modulation circuit CUS modulates the feedback signal EAO1 that is transmitted from the output terminal of the error amplifier ERR to the first input terminal of the first comparator CMP1 according to the sensed current IL.

For example, as marked by a dotted circle in FIG. 2, the current sensing modulation circuit CUS reduces the feedback signal EAO1 that is outputted from the output terminal of the error amplifier ERR to the first input terminal of the first comparator CMP1. As a result, the voltage of the first input terminal of the first comparator CMP1 is increased earlier to reach the ramp voltage RAMP1 that is a voltage of a ramp signal RAMS1 shown in FIG. 2. The second input terminal of the first comparator CMP1 receives the ramp voltage RAMP1.

If the power receiving component REA is connected between the output terminal of the error amplifier ERR and the first input terminal of the first comparator CMP1, the current sensing modulation circuit CUS reduces a voltage of the modulation node NM1 between the second terminal of the power receiving component REA and the first input terminal of the first comparator CMP1.

A voltage of the power receiving component REA is changed with a change in the feedback signal EAO1 that is transmitted through the power receiving component REA from the output terminal of the error amplifier ERR. A voltage of the second terminal of the power receiving component REA is inputted to the first input terminal of the first comparator CMP1. Therefore, the voltage of the first input terminal of the first comparator CMP1 is changed with a change in the voltage of the second terminal of the power receiving component REA.

It is worth noting that, the current sensing modulation circuit CUS modulates, (e.g., reduces) the voltage of the modulation node NM1 between the second terminal of the power receiving component REA and the first input terminal of the first comparator CMP1. As a result, the voltage of the first input terminal of the first comparator CMP1 is changed earlier to approach a voltage the ramp voltage RAMP1 of the second input terminal of the first comparator CMP1. Therefore, the first comparing signal outputted by the output terminal of the first comparator CMP1 transits earlier from a first level (such as a low level) to a second level (such as a high level).

The control circuit CTR outputs a control signal according to the first comparing signal from the output terminal of the first comparator CMP1. The driver circuit DRV drives the high-side switch HS and the low-side switch LS according to the control signal from the control circuit CTR.

In the power converter of the first embodiment of the present disclosure, the first comparing signal outputted from the output terminal of the first comparator CMP1 transits earlier from the first level (such as the low level) to the second level (such as the high level). Therefore, the control circuit CTR, according to the first comparing signal, controls the driver circuit DRV earlier to switch the high-side switch HS and the low-side switch LS for reducing an on-time of the low-side switch LS. As a result, the current IL that flows from the inductor L to the low-side switch LS is reduced.

Therefore, when the load connected to the output terminal of the power convertor of the present disclosure transits from a (super) light load to a medium load or a heavy load such that power required for the load is increased, the power converter of the present disclosure is capable of supplying sufficient power to the load. Furthermore, the on-time of the low-side switch LS is reduced such that the current IL flowing through the low-side switch LS is decreased, thereby preventing the low-side switch LS from being damaged due to overcurrent.

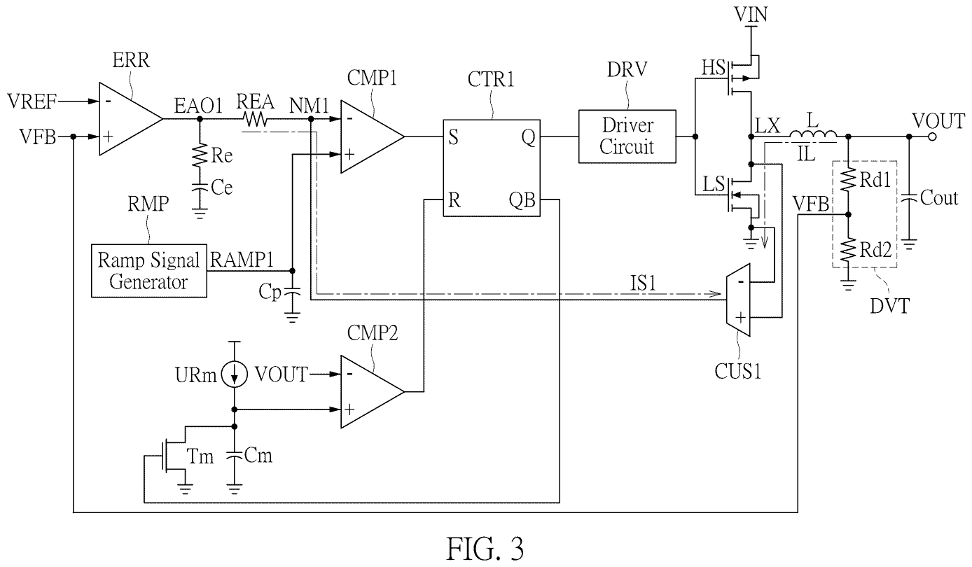

Reference is made to FIG. 3, which is a circuit diagram of the power converter having the voltage modulated based on low-side sensed data according the second embodiment of the present disclosure.

The descriptions of the second embodiment of the present disclosure that are the same as the descriptions of the first embodiment of the present disclosure are not repeated herein.

Differences between the second and first embodiments of the present disclosure are described as follows.

The power converter of the present disclosure may include a first capacitor Ce, a first resistor Re, or a combination thereof. A first terminal of the first resistor Re is connected to an output terminal of the error amplifier ERR. A second terminal of the first resistor Re is connected to a first terminal of the first capacitor Ce. A second terminal of the first capacitor Ce is grounded. The first resistor Re is connected between an error amplifying node and the first terminal of the first capacitor Ce. The error amplifying node is a node between the output terminal of the error amplifier ERR and the first terminal of the power receiving component REA.

The power converter of the present disclosure may further include a reference capacitor Cp. A first terminal of the reference capacitor Cp is connected to the second input terminal of the first comparator CMP1 and an output terminal of the ramp signal generator RMP. A first terminal of the reference capacitor Cp receives the ramp signal having the ramp voltage RAMP1 from the ramp signal generator RMP. A second terminal of the reference capacitor Cp is grounded.

The voltage of the second input terminal of the first comparator CMP1 may be connected to the ramp signal generator RMP. The ramp signal generator RMP may output the ramp signal having the ramp voltage RAMP1 to the second input terminal of the first comparator CMP1. Alternatively, the ramp signal generator RMP outputs the ramp signal to the reference capacitor Cp for charging the reference capacitor Cp, and the second input terminal of the first comparator CMP1 obtains a voltage of the reference capacitor Cp as the ramp voltage RAMP1.

The power converter of the second embodiment of the present disclosure includes a current sensing modulation circuit CUS1 shown in FIG. 3. The current sensing modulation circuit CUS1 includes a current sensing amplifier. A first input terminal such as a non-inverting input terminal of the current sensing amplifier is connected to the first terminal of the low-side switch LS. A second input terminal such as an inverting input terminal of the current sensing amplifier is connected to the second terminal of the low-side switch LS.

It is worth noting that, the current sensing modulation circuit CUS1 may sense the current IL flowing through the low-side switch LS and amplify the current IL. Then, the current sensing modulation circuit CUS1 may, according to the amplified current IL, modulate the feedback signal EAO1 that flows from the output terminal of the error amplifier ERR through the power receiving component REA to the first input terminal of the first comparator CMP1. As a result, the voltage of the modulation node NM1 between the second terminal of the power receiving component REA and the first input terminal of the first comparator CMP1 is modulated (e.g., reduced).

For example, the current sensing modulation circuit CUS1 allows a current IS1 from the modulation node NM1 between the second terminal of the power receiving component REA and the first input terminal of the first comparator CMP1 to flow into the current sensing modulation circuit CUS1 for reducing the voltage of the modulation node NM1. As a result, the voltage of the first input terminal of the first comparator CMP1 is reduced.

The voltage that is received from the modulation node NM1 by the first input terminal of the first comparator CMP1 is earlier reduced to reach the ramp voltage RAMP1 of the second input terminal of the first comparator CMP1. As a result, the first comparing signal outputted by the output terminal of the first comparator CMP1 is earlier transited from a low level to a high level. Therefore, the control circuit CTR1 earlier controls the driver circuit DRV to switch the low-side switch LS from an on-state to an off-state and switches the high-side switch HS from the off-state to the on-state for earlier stopping increasing the current IL that flows from the inductor L to the low-side switch LS.

If necessary, the power converter of the present disclosure may further include a second comparator CMP2, an input current source URm, an input capacitor Cm and a transistor Tm as shown in FIG. 3. In practice, the input current source URm, the input capacitor Cm, the transistor Tm, or any combination thereof may be omitted.

A first input terminal such as an inverting input terminal of the second comparator CMP2 is connected to the second terminal of the inductor L or the first terminal of the output capacitor Cout, and receives the output voltage VOUT from the second terminal of the inductor L or the first terminal of the output capacitor Cout.

A first terminal of the input capacitor Cm is connected to the input current source URm and a second input terminal such as a non-inverting input terminal of the second comparator CMP2.

The input current source URm supplies an input current to the input capacitor Cm for charging the input capacitor Cm. A voltage of the input capacitor Cm is inputted to the second input terminal of the second comparator CMP2.

For example, as shown in FIG. 2, the control circuit CTR1 may include an SR flip-flop, but the present disclosure is not limited thereto. A first input terminal S of the SR flip-flop is connected to the output terminal of the first comparator CMP1. A second input terminal R of the SR flip-flop is connected to an output terminal of the second comparator CMP2. An output terminal Q of the SR flip-flop is connected to the input terminal of the driver circuit DRV and configured to output the control signal to the input terminal of the driver circuit DRV.

A first terminal of the transistor Tm is connected to a first terminal of the input capacitor Cm. A second terminal of the transistor Tm is grounded. An inverting output terminal QB of the SR flip-flop included in the control circuit CTR is used as the output terminal of the control circuit CTR and is connected to a control terminal of the transistor Tm.

When an inverting control signal at a high level is outputted to the control terminal of the transistor Tm from the inverting output terminal QB of the SR flip-flop of the control circuit CTR, the transistor Tm is turned on. At this time, a current of the input capacitor Cm is discharged to ground through the transistor Tm such that a voltage of the second input terminal of the second comparator CMP2 is reduced for resetting the voltage of the second input terminal of the second comparator CMP2.

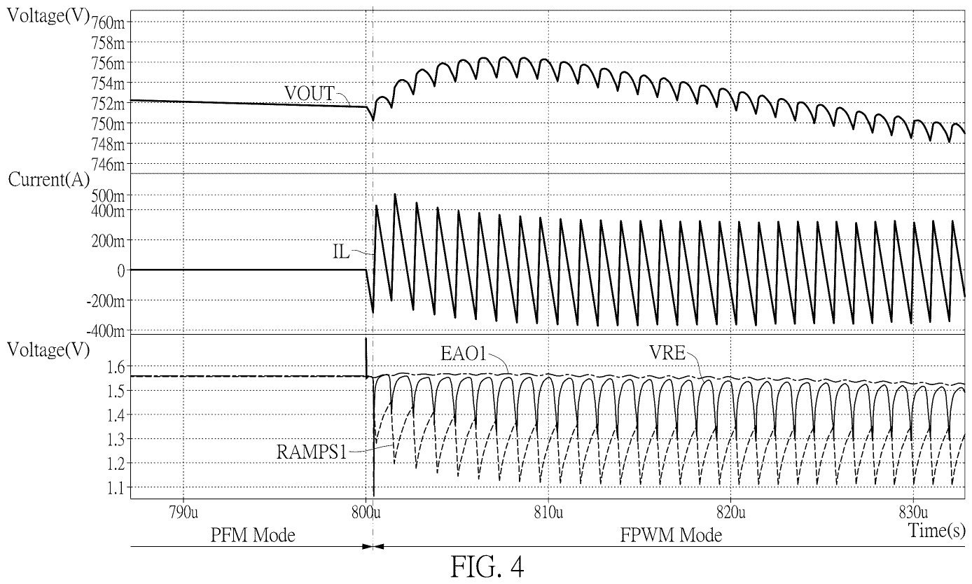

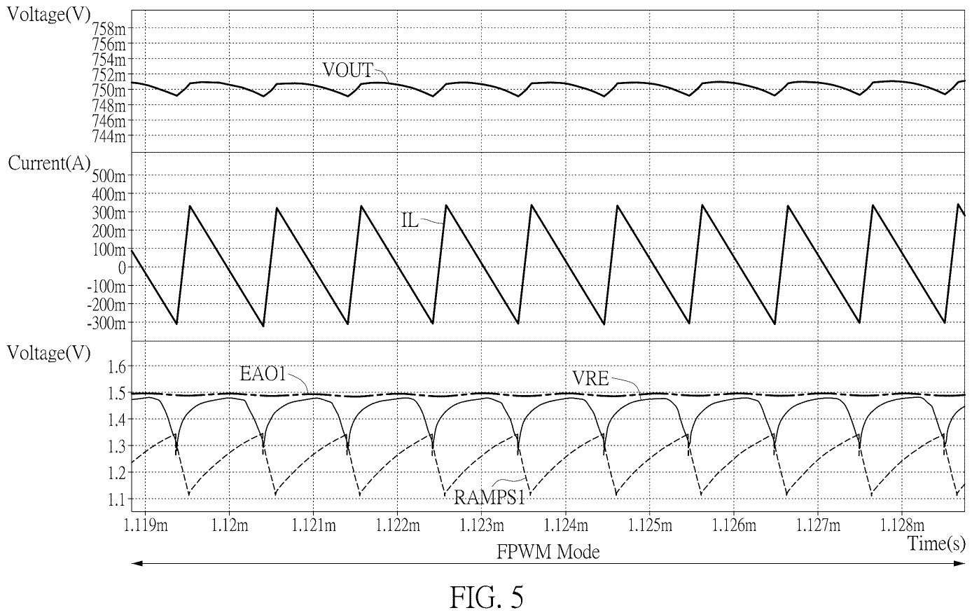

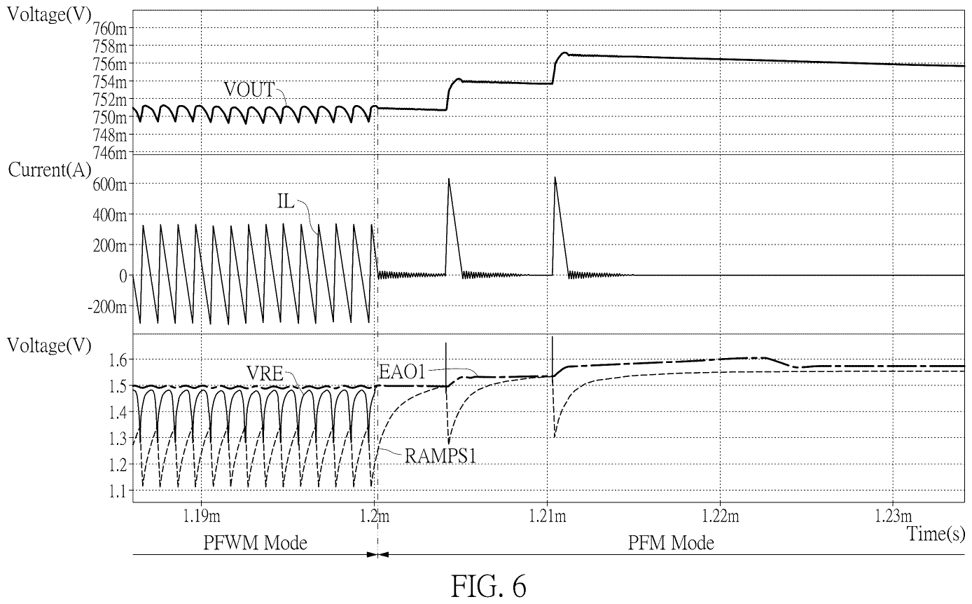

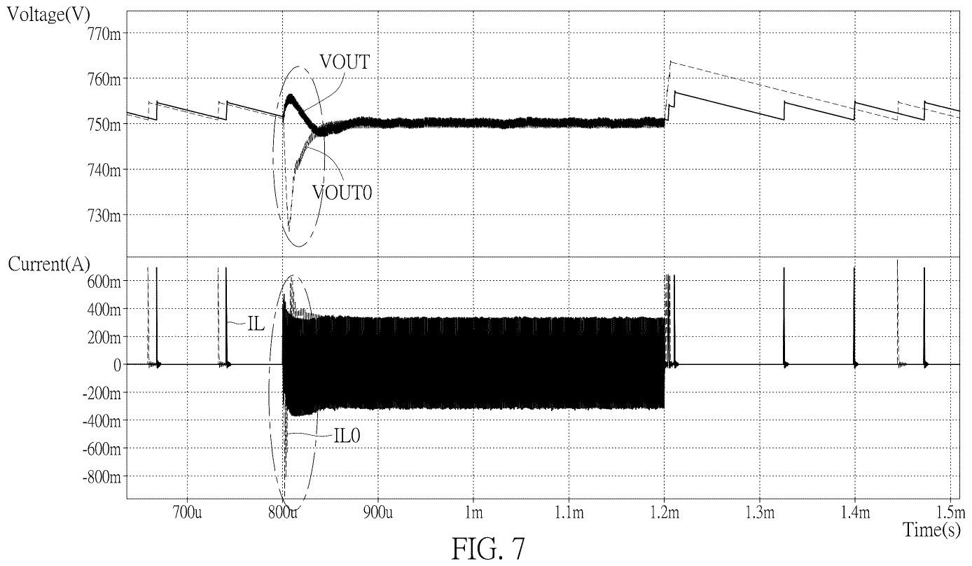

Reference is made to FIG. 3 to FIG. 7, in which FIG. 4 to FIG. 6 are waveform diagrams of signals of the power converter having the voltage modulated based on the low-side sensed data according the first and second embodiments of the present disclosure, and FIG. 7 is a waveform diagram of signals of the power converter having the voltage modulated based on the low-side sensed data according the first and second embodiments of the present disclosure.

As shown in FIG. 4 to FIG. 6, when the power converter of the present disclosure switches from a pulse-frequency modulation (PFM) mode to a frequency pulse width modulation (FPWM) mode, the output voltage VOUT of the power converter of the present disclosure is increased.

When the output voltage VOUT of the output terminal of the power converter of the present disclosure is increased to be higher than a voltage required for the load as shown in FIG. 4 to FIG. 6, the control circuit CTR shown in FIG. 1 or the control circuit CTR1 shown in FIG. 2 controls the driver circuit DRV to turn on the low-side switch LS. As a result, the current IL that flows from the output terminal of the power converter of the present disclosure sequentially through the inductor L and the low-side switch LS to ground for discharging the current IL. At this time, the current IL is gradually increased such that the output voltage VOUT of the output terminal of the power converter of the present disclosure is reduced.

The current sensing modulation circuit CUS shown in FIG. 1 or the current sensing modulation circuit CUS1 shown in FIG. 2 senses the current IL flowing through the low-side switch LS.

When the current sensing modulation circuit CUS or CUS1 determines that the current IL is reduced to reach a current threshold, the current sensing modulation circuit CUS or CUS1 reduces a voltage of a voltage signal VRE of the second terminal of the power receiving component REA as shown in FIG. 4 to FIG. 6. As a result, the voltage of the voltage signal that is received from the second terminal of the power receiving component REA by the first input terminal of the first comparator CMP1 is earlier reduced to be equal to or higher than the voltage of the ramp signal RAMS1 that is received by the second input terminal of the first comparator CMP1. The first comparing signal outputted by the first comparator CMP1 earlier transits from the low level to the high level.

The control circuit CTR shown in FIG. 1 or the control circuit CTR1 shown in FIG. 2, according to the first comparing signal, earlier controls the driver circuit DRV to switch the low-side switch LS from the on-state to the off-state and to switch the high-side switch HS from the off-state to the on-state. Therefore, the current IL that flows to the output terminal of the present disclosure through the inductor L is prevented from being reduced to too low a voltage value.

As shown in FIG. 7, a low-side switch and other circuit components of the conventional power converter are damaged by an excessive current IL0 that flows from an output terminal of the conventional power converter through the low-side switch of the conventional power converter to ground. An output voltage VOUT0 of the conventional power converter is reduced to too low a voltage value, such that the output terminal of the conventional power converter supplies insufficient power to a load.

In contrast, the current IL that flows from the output terminal of the power converter of the first and second embodiments of present disclosure through the inductor L to ground does not have an excessive current value and is maintained at an appropriate voltage value. Therefore, the power converter of the first and second embodiments of the present disclosure does not damaged and supplies sufficient power to the load.

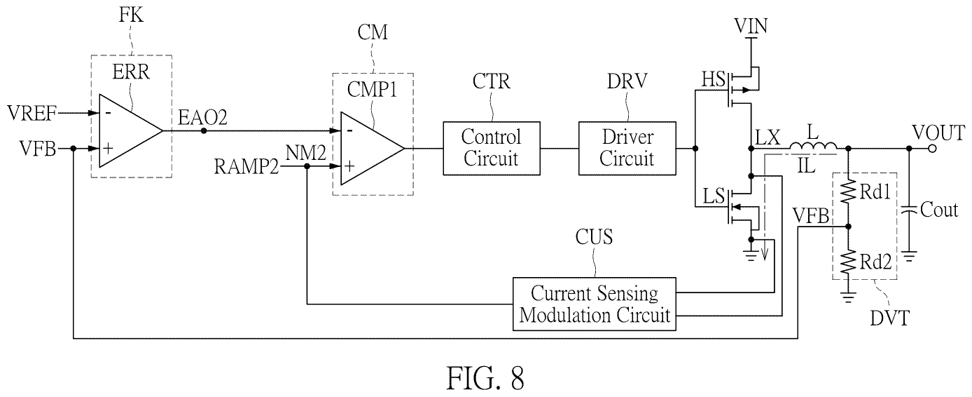

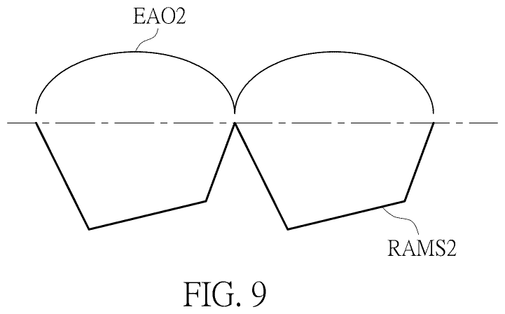

Reference is made to FIG. 8 and FIG. 9, in which FIG. 8 is a circuit diagram of a power converter having a voltage modulated based on low-side sensed data according a third embodiment of the present disclosure, and FIG. 9 is a waveform diagram of signals of the power converter having the voltage modulated based on the low-side sensed data according the third and fourth embodiments of the present disclosure.

The descriptions of the third embodiment of the present disclosure that are the same as the descriptions of the first embodiment of the present disclosure are not repeated herein.

Differences between the third and first embodiments of the present disclosure are described as follows.

As shown in FIG. 1, in the first embodiment, the current sensing modulation circuit CUS modulates (e.g., reduces) a voltage the feedback signal EAO1 (such as the error amplified signal) or the voltage of the modulation node NM1 between the second terminal of the power receiving component REA and the first input terminal of the first comparator CMP1 for modulating the voltage of the first input terminal of the first comparator CMP1.

As shown in FIG. 8 and FIG. 9, in the third embodiment, the current sensing modulation circuit CUS modulates, for example, increases, a ramp voltage RAMP2 or a voltage of a ramp signal RAMPS2 for modulating the voltage of the second input terminal of the first comparator CMP1.

As shown in FIG. 8, the second input terminal of the first comparator CMP1 is coupled to the ramp voltage RAMP2. The current sensing modulation circuit CUS is connected to a modulation node NM2 between the second input terminal of the first comparator CMP1 and the ramp voltage RAMP2.

The current sensing modulation circuit CUS senses the current IL that flows from the inductor L to the low-side switch LS, and modulates the ramp voltage RAMP2 inputted to the second input terminal of the first comparator CMP1 according to the sensed current IL for modulating the first comparing signal outputted by the first comparator CMP1.

For example, the current sensing modulation circuit CUS increases the voltage (that is the ramp voltage RAMP2) of the ramp signal RAMPS2 shown in FIG. 9. As a result, the voltage of the ramp signal RAMPS2 received by the second input terminal of the first comparator CMP1 earlier reaches the voltage of the error amplified signal received by the first input terminal of the first comparator CMP1. The first comparing signal outputted by the first comparator CMP1 earlier transits from the low level to the high level. The control circuit CTR earlier controls the driver circuit DRV to switch the low-side switch LS from the on-state to the off-state and to switch the high-side switch HS from the off-state to the on-state for earlier stopping increasing the current IL that flows from the inductor L to the low-side switch LS.

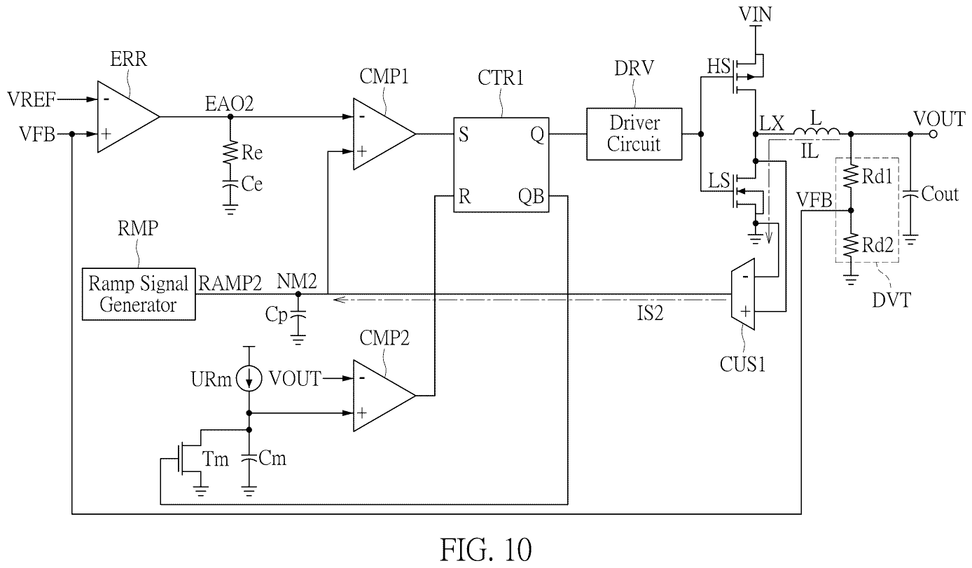

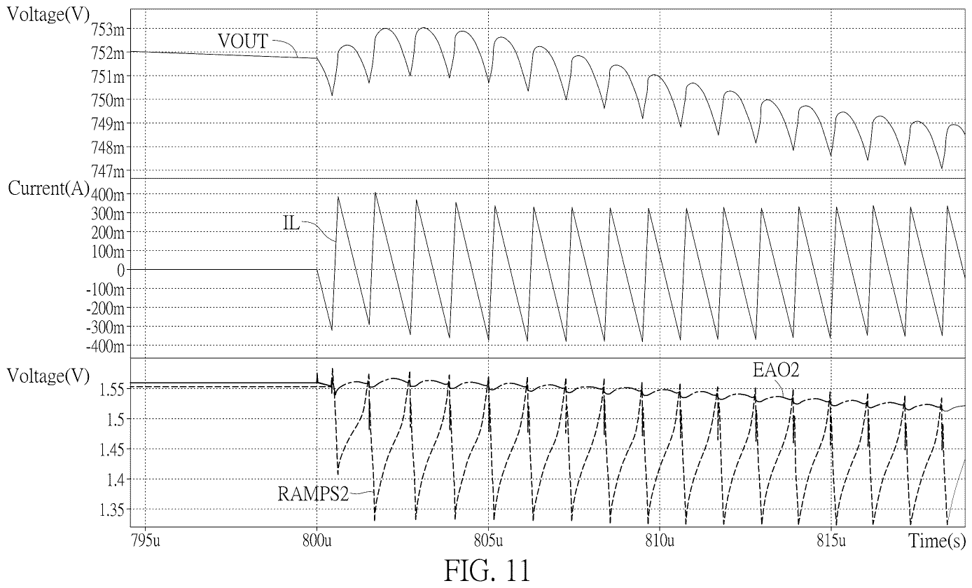

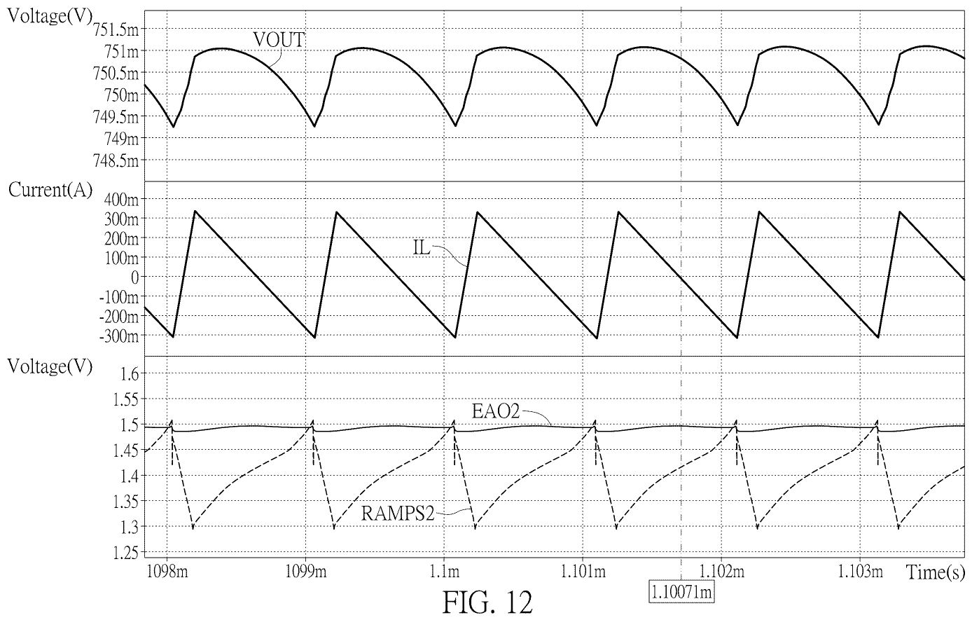

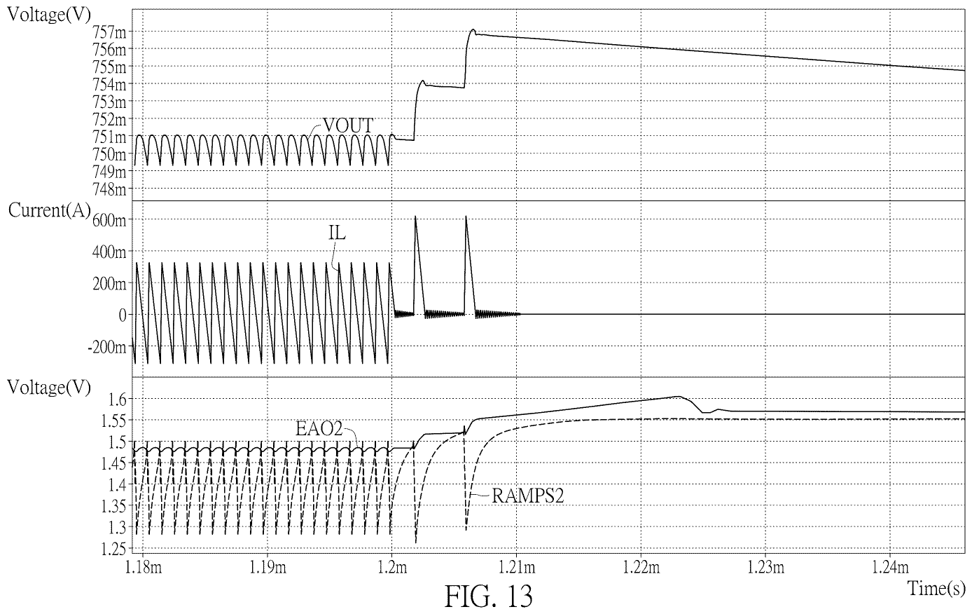

Reference is made to FIG. 10 to FIG. 13, in which FIG. 10 is a circuit diagram of the power converter having the voltage modulated based on low-side sensed data according the fourth embodiment of the present disclosure, and FIG. 11 to FIG. 13 are waveform diagrams of signals of the power converter having the voltage modulated based on the low-side sensed data according the third and fourth embodiments of the present disclosure.

A difference between the third and fourth embodiments of the present disclosure is that, the power converter of the fourth embodiment of the present disclosure further includes some of the circuit components shown in FIG. 3, the same descriptions of which are not repeated in the following.

It is worth noting that, in the fourth embodiment, the current sensing modulation circuit CUS1 amplifies the current IL flowing through the low-side switch LS, and modulates (e.g., increases) the ramp voltage RAMP2 of the ramp signal RMPS2 that is outputted to the reference capacitor Cp from the ramp signal generator RMP according to the amplified current IL. As a result, the voltage of the reference capacitor Cp that is inputted to the second input terminal of the first comparator CMP1 is modulated so as to modulate a level of the first comparing signal that is outputted to the control circuit CTR1 from the output terminal of the first comparator CMP1.

For example, the current sensing modulation circuit CUS1 amplifies the current IL flowing through the low-side switch LS to output a current amplified signal to the reference capacitor Cp, or outputs a modulation current IS2 to the reference capacitor Cp according to the sensed current IL. The reference capacitor Cp is charged by the current amplified signal or the sensed current IL together with the ramp voltage RAMP2 of the ramp signal RMPS2 outputted by the ramp signal generator RMP.

As shown in FIG. 11 to FIG. 13, the voltage of the ramp signal RAMPS2 (that is the ramp voltage RAMP2 shown in FIG. 10) is earlier increased to be equal to or higher than a voltage of a feedback signal EAO2 outputted by the error amplifier ERR. The feedback signal EAO2 is inputted to the second input terminal of the first comparator CMP1. As a result, the control circuit CTR, according to the ramp signal RAMPS2, earlier controls the driver circuit DRV to switch the high-side switch HS and the low-side switch LS.

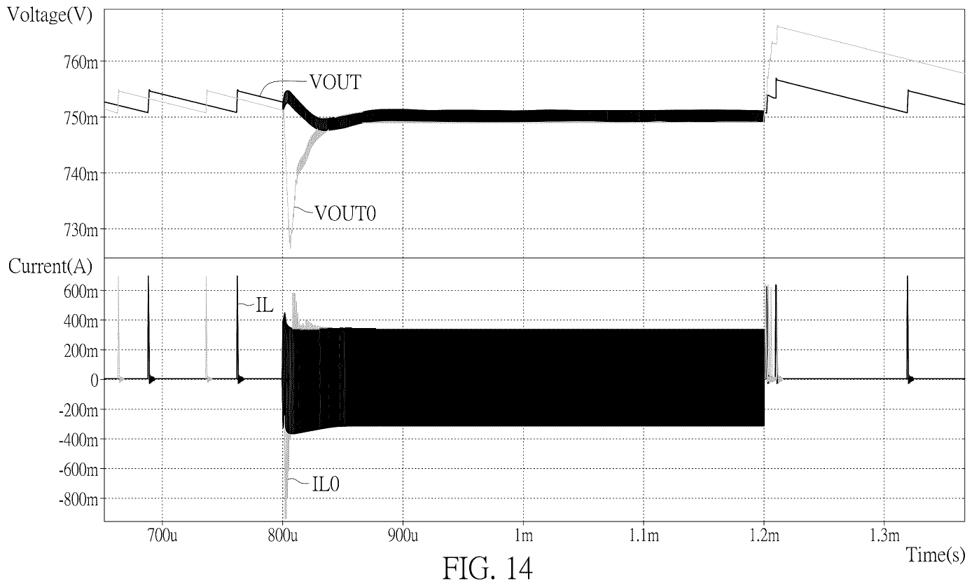

Reference is made to FIG. 14, which is a waveform diagram of signals of the power converter having the voltage modulated based on the low-side sensed data according the third and fourth embodiments of the present disclosure and a conventional power converter.

As shown in FIG. 14, the excessive current IL0 flows from the output terminal of the conventional power converter through the low-side switch to ground. As a result, the low-side switch and other circuit components of the conventional power converter are damaged by the excessive current IL0, and the output voltage VOUT0 of the output terminal of the conventional power converter is reduced to too low a voltage value. Therefore, the conventional power converter supplies insufficient power to a load.

In contrast, the current IL that flows from the output terminal of the power converter of the third and fourth embodiments of present disclosure through the low-side switch LS to ground does not have an excessive current value and is maintained at an appropriate voltage value. The power converter of the third and fourth embodiments of the present disclosure is not damaged due to overcurrent. The output terminals of power converter of the third and fourth embodiments of the present disclosure supplies sufficient power to the load.

In conclusion, the present disclosure provides the power converter having the voltage modulated based on the low-side sensed data. In the power converter of the present disclosure, the current sensing modulation circuit (including the current sensing amplifier) senses the current that flows from the inductor to the low-side switch. The current sensing modulation circuit, according to the sensed current, modulates the feedback signal that is outputted to the comparison circuit based on the output voltage of the power converter, or modulates the ramp signal that is compared with the feedback signal. As a result, in the power converter of the present disclosure, the control circuit more quickly switches the high-side switch and the low-side switch according to the first comparing signal from the first comparator. Therefore, the power converter of the present disclosure is capable of more quickly supplying sufficient power to the load connected thereto.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A power converter having a voltage modulated based on low-side sensed data, comprising:
a high-side switch, wherein a first terminal of the high-side switch is coupled to an input voltage;
a low-side switch, wherein a first terminal of the low-side switch is connected to a second terminal of the high-side switch, a second terminal of the low-side switch is grounded, a node between the first terminal of the low-side switch and the second terminal of the high-side switch is connected to a first terminal of an inductor, and a second terminal of the inductor is used as an output terminal of the power converter;
a feedback circuit connected to the second terminal of the inductor and configured to output a feedback signal according to an output voltage of the second terminal of the inductor;
a current sensing modulation circuit connected to the feedback circuit, configured to sense a current that flows from the output terminal of the power converter sequentially through the inductor and the low-side switch, and configured to modulate the feedback signal or a ramp voltage according to the current being sensed;
a comparison circuit connected to the feedback circuit and configured to compare a voltage of the feedback signal with the ramp voltage to output a first comparing signal;
a control circuit connected to the comparison circuit and configured to output a control signal according to the first comparing signal; and
a driver circuit connected to the control circuit, a control terminal of the high-side switch and a control terminal of the low-side switch, and configured to drive the high-side switch and the low-side switch according to the control signal.

2. The power converter according to claim 1, wherein the second terminal of the inductor is connected to a first terminal of an output capacitor, and a second terminal of the output capacitor is grounded.

3. The power converter according to claim 1, further comprising:
a voltage divider circuit connected to the second terminal of the inductor and the feedback circuit, and configured to divide the output voltage from the second terminal of the inductor to output a divided voltage;
wherein the feedback circuit is configured to output the feedback signal according to the divided voltage.

4. The power converter according to claim 1, wherein the feedback circuit includes:
an error amplifier, wherein a first input terminal of the error amplifier is coupled to a first reference voltage, a second input terminal of the error amplifier is connected to the second terminal of the inductor, and an output terminal of the error amplifier is connected to an input terminal of the comparison circuit.

5. The power converter according to claim 1, wherein the current sensing modulation circuit is configured to amplify the current and modulate the feedback signal or the ramp voltage according to the current being amplified.

6. The power converter according to claim 1, wherein the comparison circuit includes:
a first comparator, wherein a first input terminal of the first comparator is connected to an output terminal of the feedback circuit, a second input terminal of the first comparator is coupled to the ramp voltage, and an output terminal of the first comparator is connected to an input terminal of the control circuit.

7. The power converter according to claim 6, wherein the second input terminal of the first comparator is connected to a ramp signal generator, and the second input terminal of the first comparator receives a ramp signal having the ramp voltage from the ramp signal generator.

8. The power converter according to claim 6, further comprising:
a power receiving component, wherein a first terminal of the power receiving component is connected to the output terminal of the feedback circuit, and a second terminal of the power receiving component is connected to the first input terminal of the first comparator.

9. The power converter according to claim 8, further comprising:
a first capacitor, wherein a first terminal of the first capacitor is connected to an error amplifying node between the output terminal of the feedback circuit and the first terminal of the power receiving component, and a second terminal of the first capacitor is grounded.

10. The power converter according to claim 9, further comprising:
a first resistor connected between the error amplifying node and the first terminal of the first capacitor.

11. The power converter according to claim 8, wherein the current sensing modulation circuit is connected to a modulation node between the second terminal of the power receiving component and the first input terminal of the first comparator, and configured to modulate a voltage of the modulation node according to the current.

12. The power converter according to claim 11, wherein the current sensing modulation circuit allows a current from the modulation node to flow into the current sensing modulation circuit for reducing the voltage of the modulation node.

13. The power converter according to claim 6, further comprising:
a second comparator, wherein a first input terminal of the second comparator is connected to the second terminal of the inductor and configured to receive the output voltage of the second terminal of the inductor, a second input terminal of the second comparator is coupled to a threshold voltage, and an output terminal of the second comparator is connected to the input terminal of the control circuit.

14. The power converter according to claim 13, further comprising:
an input current source configured to supply an input current; and
an input capacitor, wherein a first terminal of the input capacitor is connected to the input current source and the second input terminal of the second comparator, and a voltage of the first terminal of the input capacitor is used as the threshold voltage, and a second terminal of the input capacitor is grounded.

15. The power converter according to claim 14, further comprising:
a transistor, wherein a first terminal of the transistor is connected to the first terminal of the input capacitor, a second terminal of the transistor is grounded, and a control terminal of the transistor is connected to an output terminal of the control circuit.

16. The power converter according to claim 1, further comprising:
a reference capacitor, wherein a first terminal of the reference capacitor is connected to an input terminal of the comparison circuit and an output terminal of a ramp signal generator, and a second terminal of the reference capacitor is grounded;
wherein the ramp signal generator is configured to output a ramp signal to the reference capacitor such that a voltage of the first terminal of the reference capacitor reaches the ramp voltage.

17. The power converter according to claim 16, wherein the current sensing modulation circuit is connected between the first terminal of the reference capacitor and the output terminal of the ramp signal generator, and configured to modulate the voltage of the first terminal of the reference capacitor according to the current.

18. The power converter according to claim 17, wherein the current sensing modulation circuit is configured to output a first current to the reference capacitor for increasing the voltage of the first terminal of the reference capacitor.
